(19) United States
(12) Patent Application Publication
(10) Pub. No.: US 2018/0361664 A1
(43) Pub. Date: Dec. 20, 2018

(54) 3D Printing Method and Apparatus

(71) Applicant: Aurora Labs Limited, Bibra Lake, Western Australia (AU)

(72) Inventor: David Budge, Applecross, Western Australia (AU)

(73) Assignee: Aurora Labs Limited, Bibra Lake, Western Australia (AU)

(21) Appl. No.: 16/063,322

(22) PCT Filed: Dec. 5, 2016
(86) PCT No.: PCT/AU2016/000388

§ 371 Date: Jun. 18, 2018

(30) Foreign Application Priority Data
Dec. 18, 2015 (AU) 2015905268

(51) Int. Cl. B29C 64/236; B29C 64/329; B29C 64/268; B29C 64/214; B29C 64/153

(52) U.S. Cl. CPC B29C 64/236; B29C 64/329; B33Y 30/00; B29C 64/214; B29C 64/153; B29C 64/268

(57) ABSTRACT

A printing apparatus is for printing a three-dimensional object comprising an operative surface, at least one supply hopper for depositing layers of powder onto the operative surface and an energy source for emitting at least one energy beam onto the layers of powder. The supply hopper and energy source are configured such that when a topmost layer of powder is being deposited onto an underlying layer of powder on the operative surface, the direction travelled by the supply hopper when depositing the topmost layer is different to the direction travelled by the supply hopper when depositing the underlying layer, and at least one energy beam is emitted onto the topmost layer and at least one further energy beam is emitted onto the underlying layer, simultaneously, to melt, fuse or sinter the topmost and underlying layers.

### FIELD OF INVENTION

The present invention relates to a 3D printing method and apparatus.

More particularly, the present invention relates to a 3D printing method and apparatus adapted for manufacturing objects at high speed.

### BACKGROUND ART

Three-dimensional (3D) printed parts result in a physical object being fabricated from a 3D digital image by laying down consecutive thin layers of material.

Typically these 3D printed parts can be made by a variety of means, such as selective laser melting or sintering, which operate by having a powder bed onto which an energy beam is projected to melt the top layer of the powder bed so that it welds onto a substrate or a substratum. This melting process is repeated to add additional layers to the substratum to incrementally build up the part until completely fabricated.

These printing methods are significantly time consuming to perform and it may take several days, or weeks, to fabricate a reasonable sized object. The problem is compounded for complex objects comprising intricate component parts. This substantially reduces the utility of 3D printers and is one of the key barriers currently impeding large-scale adoption of 3D printing by consumers and in industry.

The present invention attempts to overcome, at least in part, the aforementioned disadvantages of previous 3D printing methods and devices.

### SUMMARY OF THE INVENTION

In accordance with one aspect of the present invention, there is provided a printing apparatus for printing a three-dimensional object, comprising:
an operative surface;
at least one supply hopper for depositing layers of powder onto the operative surface; and
an energy source for emitting at least one energy beam onto the layers of powder,
   wherein the supply hopper and energy source are configured such that when a topmost layer of powder is being deposited onto an underlying layer of powder on the operative surface:
the direction that the supply hopper is moving in while depositing the topmost layer is different to the direction that the supply hopper moved in when it deposited the underlying layer; and
at least one energy beam is emitted onto the topmost layer and at least one further energy beam is emitted onto the underlying layer simultaneously to melt, fuse or sinter the topmost and underlying layers simultaneously.

The supply hopper may travel along an oscillating path, transverse to the operative surface, that is substantially sinusoidal.

The supply hopper may travel along an oscillating path, transverse to the operative surface, that conforms to a square, triangular or other wave form.

The apparatus may comprise a levelling means for substantially levelling a layer of powder deposited on the operative surface.

The levelling means may comprise a blade that, in use, periodically scrapes an upper surface of a layer of powder.

The levelling means may comprise an electrostatic charging means.

The levelling means may comprise a vibration generation means for applying vibrational forces to particles comprised in the layer of powder.

The vibration generation means may comprise a mechanical vibration generator.

The vibration generation means may comprise an ultra-sonic vibration generator.

The apparatus may comprise a scanning means for determining a position, velocity and/or size of one or more particles comprised in the powder when the, or each, particle is travelling between the supply hopper and the operative surface.

The scanning means may be adapted to measure the airborne density of the powder.

The scanning means may be adapted to measure a volume of powder deposited on the operative surface.

The scanning means may be adapted to measure a level of the powder deposited on the operative surface.

The scanning means may be adapted to measure a topology of a powder layer or part thereof.

The scanning means may be adapted to measure a chemical composition of a powder layer or part thereof.

The scanning means may be adapted to measure a temperature of each powder layer or part thereof.

In accordance with one further aspect of the present invention, there is provided a method for printing a three-dimensional object, the method comprising the steps of:
using a supply hopper to deposit a plurality of layers of powder onto an operative surface such that when a topmost layer of powder is being deposited onto an underlying layer of powder on the operative surface, the direction moved by the supply hopper when depositing the topmost layer is different to the direction that the supply hopper moved in when depositing the underlying layer; and
using an energy source to emit an energy beam onto each topmost and underlying layer being deposited such that at least one energy beam is emitted onto the topmost layer and at least one further energy beam is emitted onto the underlying layer, simultaneously, to melt, fuse or sinter the topmost and underlying layers simultaneously.

### BRIEF DESCRIPTION OF DRAWINGS

The present invention will now be described, by way of example, with reference to the accompanying drawings, in which:

FIG. 1 is a side schematic view of a conventional 3D printing apparatus known in the art;

FIG. 2 is a side schematic view of a 3D printing apparatus according to a first embodiment of the invention;

FIG. 3 is a further side schematic view of the 3D printing apparatus of FIG. 2; and

FIG. 4 is a side schematic view of a 3D printing apparatus according to a second embodiment of the invention.

### DETAILED DESCRIPTION OF THE DRAWINGS

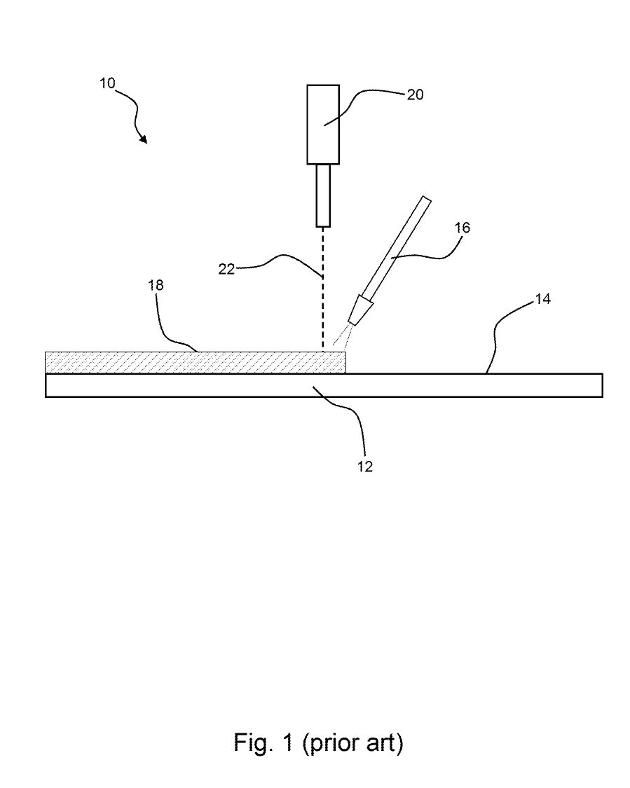

Referring to FIG. 1, there is shown a schematic representation of a conventional 3D printing apparatus 10 known in the art. The apparatus 10 comprises a substrate 12 with an operative surface 14 on which a printed object is to be fabricated by 3D printing.

The apparatus 10 further comprises a supply hopper 16 that deposits a single layer of powder 18 onto the operative surface 14.

An energy gun 20 (commonly a laser or electron gun) emits an energy beam 22 onto the layer of powder 18 causing it to melt or sinter selectively to form an individual layer of the 3D object. The process is repeated to add additional layers and incrementally build up the object until it is completed.

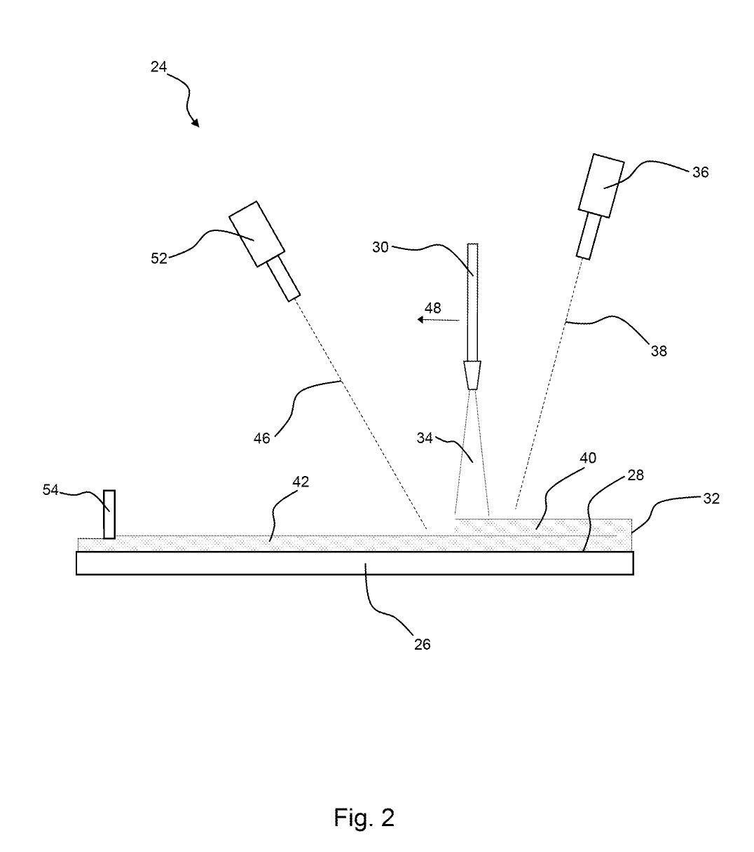

Referring to FIG. 2, there is shown a schematic representation of a 3D printing apparatus 24 according to a first embodiment of the present invention.

The apparatus 24 comprises an operative surface 28, at least one supply hopper 30 for depositing layers 32 of powder 34 onto the operative surface 28 and an energy source for emitting at least one energy beam 38 onto the layers of powder 32. The supply hopper 30 and energy source are configured such that when a topmost layer of powder 40 is being deposited onto an underlying layer of powder 42 on the operative surface 28, the direction that the supply hopper 30 is moving in while depositing the topmost layer 40 is different to the direction that the supply hopper 30 moved in when it deposited the underlying layer 42, and at least one energy beam 38 is emitted onto the topmost layer 40 and at least one further energy beam 46 is emitted onto the underlying layer 42 simultaneously to melt, fuse or sinter the topmost and underlying layers 40,42 to an underlying powder layer or substrate simultaneously.

More particularly, the apparatus 24 comprises a substrate 26 which forms the operative surface 28 on which a printed object is to be fabricated by 3D printing. In use, the supply hopper 30 travels in alternating directions, transverse to the operative surface 28, when depositing each layer of powder. In FIG. 2, for example, the apparatus 24 is shown in a state whereby a first layer of powder 42 has been deposited in full and the supply hopper 30 is actively depositing a second layer of powder 40 overlaying the first layer 42. The supply hopper 30 is shown currently traveling in the direction indicated by reference numeral 49 while the second, overlaying layer of powder 40 is being formed.

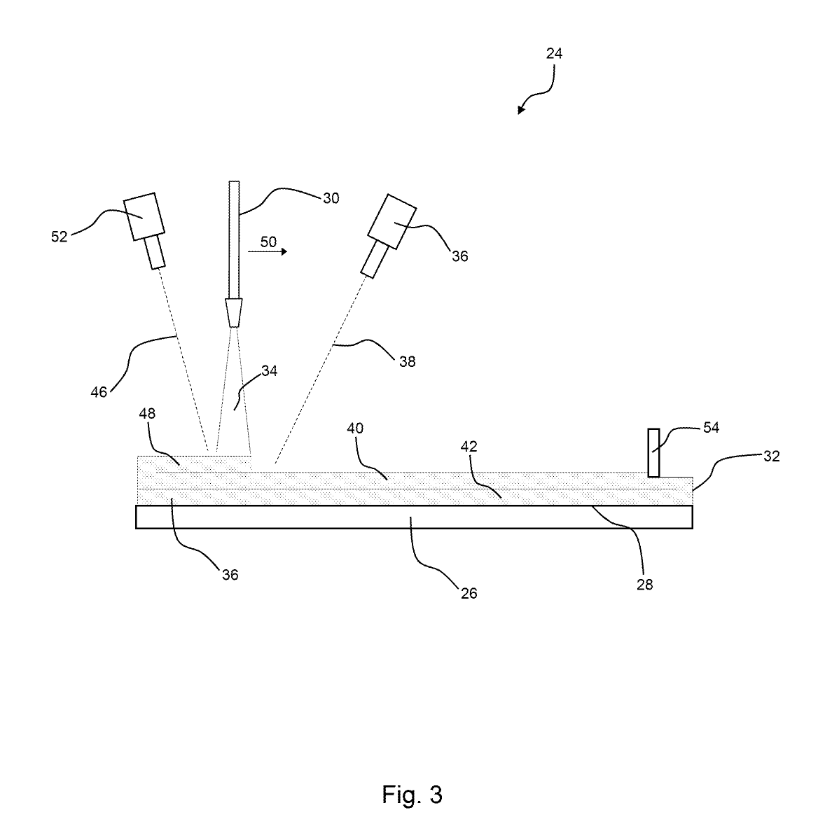

In FIG. 3, the apparatus 24 is shown in a further state whereby the first and second layers of powder 42,40 have both been deposited in full and the supply hopper 30 is actively depositing a third layer of powder 48 immediately above the second layer 40. The supply hopper 30 is shown currently traveling in the direction indicated by reference numeral 50 while forming the third layer of powder 48, which is different to the previous direction 49 that it travelled in.

The supply hopper 30 travels back and forth repeatedly, in an oscillating path, transverse to the operative surface 28, to incrementally deposit the powder layers 32 onto the operative surface 28. Preferably, the path followed by the supply hopper 30 is substantially sinusoidal in at least one dimension transverse to the planar operative surface 28. It is anticipated, however, that the supply hopper 30 may follow alternative oscillating paths which are all within scope of the present invention.

The apparatus 24 further comprises an energy source which, in the first embodiment of the invention shown in FIGS. 2 and 3, comprises a first energy gun 36 for emitting a first energy beam 38 onto the powder layers 32 and a second energy gun 52 for emitting a second energy beam 46 onto the powder layers 32 to melt or sinter the powder selectively, thereby forming part of the 3D object.

The two energy guns 36,52 operate such that the first energy beam 38 is directed onto, and works on, the topmost layer of powder that is being actively deposited by the supply hopper 30. Meanwhile, the second energy beam 46 is simultaneously directed onto, and works on, a layer of powder underlying the topmost layer.

By way of example, in FIG. 2, the first energy beam 38 is shown being directed onto the second layer of powder 40, which forms the topmost layer of powder that is being actively deposited by the supply hopper 30. Meanwhile, the second energy beam 46 is shown being directed simultaneously onto the first layer of powder 42 that has previously been deposited, in full, and is immediately underlying the second layer of powder 40.

By way of further example, in FIG. 3 the second energy beam 46 is shown being directed onto the third layer of powder 48 which, at this point in time, forms the topmost layer of powder being actively deposited by the supply hopper 30. Meanwhile, the first energy beam 38 is shown being directed, simultaneously, onto the second layer of powder 46 which, at this point in time, has now been deposited in full and forms a layer underlying the third layer of powder 48.

The present invention enables two layers of powder to be effectively operated on by the energy source simultaneously, leading to a corresponding two-fold increase in printing productivity.

The energy source used in the apparatus 24 can be any one of a laser beam, a collimated light beam, a micro-plasma welding arc, a microwave beam, an ultrasonic beam, an electron beam, a particle beam or other suitable energy beam.

In embodiments of the invention that make use of electron beam energy sources, the printing apparatus 24 (including the operative surface 28) may be contained and operated wholly inside a vacuum chamber to facilitate propagation of the electron beam onto the layers of powder.

The effectiveness of the present invention substantially relies on each powder layer 32 being formed in a controlled manner It is, in particular, important to ensure that the layers formed have uniform thicknesses and top surfaces that are substantially level when the powder layers 32 are being worked on by the energy source.

Due to the nature of powder particles, they often tend to roll across the operative surface 28 when deposited thereon. This is normally either due to the shape of the powder particles, e.g. roughly round shaped powder particles that bounce roll on the operative surface 28 and collide with other powder particles already located thereon, or the rolling can be caused by the force of the gas feed carrying the powder particles from the powder supply 30, or the rolling can be caused by gravity by the powder particles rolling off a “heap” if too many powder particles are deposited at the same position.

It is also known that the thickness of a layer of powder 32 can be reduced after the layer has been worked on by the energy source due to, for example, particle shrinkage. The reduction in thickness may detrimentally affect layers of powder subsequently deposited by the supply hopper 30 and/or the resultant 3D object that is fabricated.

The apparatus 24, therefore, additionally comprises a levelling means for substantially levelling each powder layer 32 during operation.

In the embodiment disclosed in the Figures, the levelling means comprises a blade 54 that, in use, is periodically scraped over the top surface of a layer of powder 32 in order to modify its thickness, as may be necessary, and to ensure that its top surface is kept substantially level.

The blade 54 is controlled using mechanical control means and control electronics (not shown) driven by software or firmware implementing an algorithm for controlling the position, speed and orientation of the blade 54.

The algorithm implemented may cause the blade 54 to operate selectively on any layer of powder deposited, either in whole or in part, simultaneously with or independently to the operation of the energy guns 36,52.

For example, in FIG. 2 the blade 54 is shown operating on the first layer of powder 42 that has been deposited in full, while the first and second energy guns 52,36 are operating, respectively, on the first and second powder layers 42, 40.

In FIG. 3, the blade 54 is shown operating on the second layer of powder 40 that, at this point in time, has been deposited in full, while the first and second energy guns 52,36 are operating, respectively, on the second and third powder layers 40, 48.

Instead of or in addition to the blade 54, the levelling means used by the apparatus 24 may, alternatively, comprise a vibration generation means (not shown) for applying vibrational forces to a layer of powder 32 that has yet to be melted or sintered by the energy source. These vibrational forces cause individual particles in the powder layers 32 to vibrate which, in turn, causes them to become dynamic. The vibrational forces may be applied selectively to one or more powder layers until the particles comprised in the, or each, layer form and settle into a desired arrangement.

The vibration generation means used by the apparatus 24 may be a mechanical vibration generator or, alternatively, an ultra-sonic vibration generator.

Further, instead of or in addition to the blade and/or vibration generation means, the levelling means may comprise an electrostatic charging means which electrostatically charges both the powder particles and the operative surface 28 with opposed polarities.

For example, a positive charge can be applied to the operative surface 28 and the powder particles exiting the supply 30 can be negatively charged. Thus, as the powder particles exit the supply 30 they are drawn towards the operative surface 28 and, once contact is made therewith, the powder particles stick in place on the operative surface 28.

Advantages of such adhesion is, firstly, that it results in an improved resolution of the final component as the powder particles can be accurately placed and, secondly, that working environment within the printing apparatus 24 is improved as there is less powder particle dust between the supply 30 and the operative surface 28. Further, it is also possible to control the direction of flow of the electrostatically charged powder particles using other electrostatic means.

To enable the apparatus 24 to control the volumetric flow rate and density of airborne powder 34 emitted from the supply hopper 30 and the levelling means described above, the apparatus 24, preferably, also comprises a scanning means (not shown).

The scanning means is, preferably, adapted to determine a position, velocity and/or size of one or more particles comprised in the powder 34 when the, or each, particle is travelling from the supply hopper 30 to the operative surface 28.

The scanning means is, preferably, also adapted to measure the airborne density of the powder 34.

The scanning means is, preferably, also adapted to measure a volume of powder deposited on the operative surface 28.

The scanning means is, preferably, also adapted to measure a level of the powder deposited on the operative surface 28.

The scanning means may make use of an ultra-sonic beam, an electron beam, a laser or other appropriate scanning or positioning technology.

Information and data collected using the scanning means is used, in conjunction with control electronics and software, to determine the volumetric flow rate, direction and/or velocity of powder emitted from the supply hopper 30 and/or the direction and intensity of the energy beams 46,38 to optimise fabrication of the part being printed.

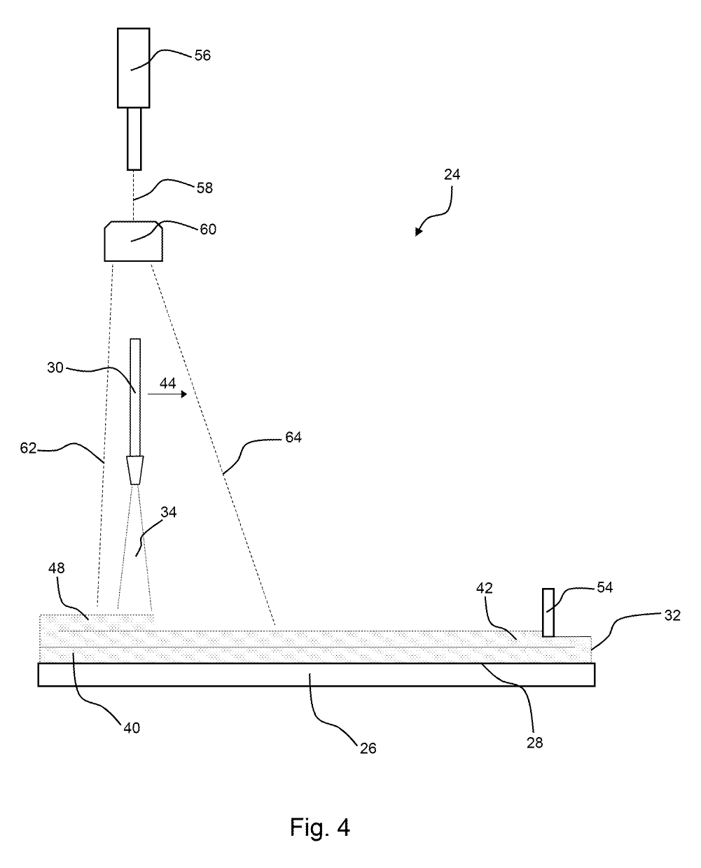

Referring to FIG. 4, there is shown a schematic representation of a 3D printing method and apparatus 24 according to a second embodiment of the present invention. The embodiment disclosed is identical in all response to the first embodiment disclosed in FIGS. 2 and 3 save that the energy source comprises a single energy gun 56 that is adapted to emit a single energy beam 58 onto an energy splitting means 60.

The energy beam splitting means 60 splits the single energy beam 58 into two individual directed energy beams 62,64. The energy beam splitting means 60 operates in conjunction with a control mechanism (not shown) which ensures that each directed energy beam 62,64 emitted from the energy beam splitting means 60 is directed, simultaneously, onto a different exposed surface of a layer of powder 32 in the same manner as described above for the first embodiment of the invention.

Further modifications and variations as would be apparent to a skilled addressee are deemed to be within the scope of the present invention.

In the preceding description of the invention and the following claims, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

1. A printing apparatus for printing a three-dimensional object, comprising:
an operative surface;
at least one supply hopper for depositing layers of powder onto the operative surface; and
an energy source for emitting at least one energy beam onto the layers of powder,
wherein the supply hopper and energy source are configured such that when a topmost layer of powder is being deposited onto an underlying layer of powder on the operative surface:
the direction travelled by the supply hopper when depositing the topmost layer is different to the direction travelled by the supply hopper when depositing the underlying layer; and
at least one energy beam is emitted onto the topmost layer and at least one further energy beam is emitted onto the underlying layer, simultaneously, to melt, fuse or sinter the topmost and underlying layers.

2. The printing apparatus according to claim 1, wherein the supply hopper is configured to travel along an oscillating path transverse to the operative surface, wherein the path is substantially sinusoidal.

3. The printing apparatus according to claim 1, wherein the apparatus further comprises a levelling means for substantially levelling a layer of powder deposited on the operative surface.

4. The printing apparatus according to claim 3, wherein the levelling means comprises a blade that is configured to, in use, periodically scrape an uppermost surface of a layer of powder on the operative surface.

5. The printing apparatus according to claim 3, wherein the levelling means comprises an electrostatic charging means.

6. The printing apparatus according to claim 3, wherein the levelling means comprises a vibration generation means for applying vibrational forces to particles comprised in a layer of powder on the operative surface.

7. The printing apparatus according to claim 6, wherein the vibration generation means comprises a mechanical vibration generator.

8. The printing apparatus according to claim 6, wherein the vibration generation means comprises an ultra-sonic vibration generator.

9. The printing apparatus according to claim 1, wherein the apparatus further comprises a scanning means for determining a position, velocity and/or size of one or more particles comprised in the powder when the, or each, particle is travelling between the supply hopper and the operative surface.

10. The printing apparatus according to claim 9, wherein the scanning means is adapted to measure the airborne density of the powder.

11. The printing apparatus according to claim 9, wherein the scanning means is adapted to measure a volume of powder deposited on the operative surface.

12. The printing apparatus according to claim 9, wherein the scanning means is adapted to measure a level of the powder deposited on the operative surface.

13. The printing apparatus according to claim 9, wherein the scanning means is adapted to measure a topology of a powder layer or part thereof.

14. The printing apparatus according to claim 9, wherein the scanning means is adapted to measure a chemical composition of a powder layer or part thereof.

15. The printing apparatus according to claim 9, wherein the scanning means is adapted to measure a temperature of each powder layer or part thereof.

16. The printing apparatus according to claim 1, wherein the apparatus comprises a plurality of energy sources for emitting a plurality of energy beams, wherein the energy beams are each directed onto a common focus.

17. The printing apparatus according to claim 1, wherein the apparatus further comprises an energy beam splitting means for splitting the energy beam into a plurality of separate energy beams and directing each separate energy beam onto a common focus.
